(19) United States
(12) Patent Application Publication
(10) Pub. No.: US 2026/0073295 A1
(43) Pub. Date: Mar. 12, 2026

(54) GENERATIVE RESPONSE ENGINE USING CHAIN-OF-THOUGHT REASONING

(71) Applicant: OpenAI OpCo, LLC., San Francisco, CA (US)

(72) Inventors: Peter Vidani, San Francisco, CA (US); Valerie Qi, San Francisco, CA (US)

(73) Assignee: OpenAI OpCo, LLC., San Francisco, CA (US)

(21) Appl. No.: 19/170,839

(22) Filed: Apr. 4, 2025

Related U.S. Application Data
(60) Provisional application No. 63/693,683, filed on Sep. 11, 2024.

(51) Int. Cl. G06N 20/00

(52) U.S. Cl. CPC G06N 20/00

(57) ABSTRACT

The present technology pertains to a generative response system (system) that includes a chain-of-thought (CoT) reasoning model. The system receives a prompt for a response, wherein the response benefits from multi-step, CoT reasoning. The prompt is tokenized to generate input tokens, which can also include tokens representing a contextual conversation history. A first machine learning (ML) model having a CoT functionality processes the input tokens, generating reasoning tokens, which explore one or more reasoning frameworks for responding to the prompt. The combination of the first and second tokens is processed to generate output tokens representing the response sent to the requester. The second tokens are not provided to the requester and are omitted from the chat history. However, a summary of the multi-step reasoning framework used to generate the response can be generated based on the second tokens and presented to the requester.

### CROSS-REFERENCE TO RELATED APPLICATIONS

This application claims priority to and the benefit of U.S. provisional application No. 63/693,683, filed on Sep. 11, 2024, which is expressly incorporated by reference herein in its entirety.

### BACKGROUND

Generative response engines such as large language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

Large language models (LLMs) using autoregressive artificial intelligence (AI) systems can perform well at certain tasks, such as one-shot inference or single-step reasoning, due to their training on vast amounts of diverse data, which enables them to predict the most likely next step or answer in a sequence. In autoregressive models, each word or token is generated based on the preceding ones, allowing the model to adapt quickly to new inputs without needing extensive retraining.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates a block diagram of an example system supporting a generative response engine during inference operations in accordance with some embodiments of the present technology.

FIG. 2A illustrates an aspect of the subject matter in accordance with one embodiment.

FIG. 2B illustrates a block diagram of an example system supporting a chain-of-thought reasoning model during inference operations in accordance with some embodiments of the present technology.

FIG. 3 illustrates a flow diagram of an example of a method for implementing some embodiments of the present technology.

FIG. 4 illustrates an example of a process flow for implementing some embodiments of the present technology.

FIGS. 5A-5G illustrate examples of respective views of a user interface in accordance with some embodiments of the present technology.

FIG. 6 illustrates an example of a user interface providing an arrangement of a summary of chain-of-thought reasoning displayed side-by-side with a response to a prompt in accordance with some embodiments of the present technology.

FIG. 7A and FIG. 7B illustrate an example of a user interface providing an arrangement of a summary of chain-of-thought reasoning displayed inline with a response to a prompt in accordance with some embodiments of the present technology.

FIGS. 7A-7C illustrate an example transformer architecture in accordance with some embodiments of the present technology.

FIG. 9 illustrates a block diagram of an example machine-learning platform for implementing various aspects of this disclosure in accordance with some aspects of the present technology.

FIG. 10 shows an example of a system for implementing some embodiments of the present technology.

### DETAILED DESCRIPTION

Generative response engines such as language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they utilize the conversational user interface powered by the chatbot as they would an assistant.

However, one area in which these generative response engines could be improved is multi-step reasoning. Autoregressive models predict each token based on the previous ones in a strictly sequential manner. This means that once the autoregressive model makes a prediction, it doesn't retain or “reason” through intermediate steps in a structured way. For multi-step tasks like proofs, each step requires not just the output of the previous token, but a deeper understanding of how that step connects to the next one. Accordingly, autoregressive models tend to not do as well at problems that depend on multi-step reasoning, such as mathematical proofs, which benefit from: (1) scrutinizing or thinking about respective logical steps, (2) trying and comparing multiple different reasoning strategies, or (3) being able to backtrack once a dead end is reached.

According to certain non-limiting examples, the systems and methods disclosed herein use a chain-of-thought (CoT) reasoning model (or CoT model for short) that uses a combination of reinforcement learning and chain-of-thought reasoning to generate reasoning tokens that are combined with the input tokens to provide an input to a generative response engine, which uses the combination of reasoning tokens and input tokens to generate a response that is then provided to the user. Through reinforcement learning, the CoT model can learn to refine its reasoning process, explore different strategies, recognize mistakes, and adapt its approach to arrive at the most accurate and logical solution. The CoT model can also use chain-of-thought reasoning, which breaks down complex problems into smaller, more manageable components. Chain-of-thought reasoning allows the CoT model to effectively reason before answering the prompt. Further, by explicitly outlining the reasoning process, the CoT model can identify potential errors early on and increase the likelihood of arriving at the correct solution.

According to certain non-limiting examples, the response from the generative response engine is provided to the user but the reasoning tokens are not. Further, a summary of the CoT reasoning (e.g., the reasoning tokens) can also be generated and provided to the user, but the summary is not included in the context of the conversation. The summary can provide the user with a step-by-step summarization of the reasoning process, which provides transparency and provides the user with a path to double-check and verify the result/response. The summary has the benefits of: (1) building trust in how the CoT system reasons and approaches problems; (2) providing the user a useful glimpse into what is happening in the CoT system before they get the response from the generative response engine; and (3) suggesting to the user a path (e.g., a series of step) that can be used to verify the reasoning process and/or pinpoint potential mistakes of the reasoning process.

According to certain non-limiting examples, reasoning models are language models trained with reinforcement learning to perform complex reasoning. Reasoning models think before they answer, producing a long internal chain of reason before responding to the user.

Reasoning models can excel in complex problem solving, coding, scientific reasoning, and multi-step planning for agentic workflows. CoT reasoning models can be slower and more expensive than other autoregressive models. CoT reasoning models, however, can generate better responses for complex tasks, and generalize better across domains.

According to certain non-limiting examples, the CoT reasoning can use a method of problem-solving or decision-making where each step is logically connected to the next. CoT reasoning can apply a process of explicitly reasoning through intermediate steps or breaking down complex problems into smaller, manageable parts. This technique is useful for tackling problems that depend on deeper or more systematic reasoning.

According to certain non-limiting examples, the CoT system receives a prompt that is a request for a response, and the response is based on multi-step reasoning, which can be provided by a chain-of-thought (CoT) reasoning model, which can be shortened to CoT model. The prompt is tokenized to generate input tokens, which can also include tokens representing a contextual conversation history. A first machine learning (ML) model (e.g., the CoT model) having a CoT functionality processes the input tokens, generating reasoning tokens, which explore one or more reasoning frameworks for responding to the prompt. The combination of the first and second tokens is processed to generate output tokens representing the response sent to the requester. The second tokens are not provided to the requester and are omitted from the chat history. However, a summary of the multi-step reasoning framework used to generate the response can be generated based on the second tokens and presented to the requester.

Generating the summary does not necessarily benefit from CoT reasoning and can be more efficiently generated using a language model that lacks a CoT reasoning functionality.

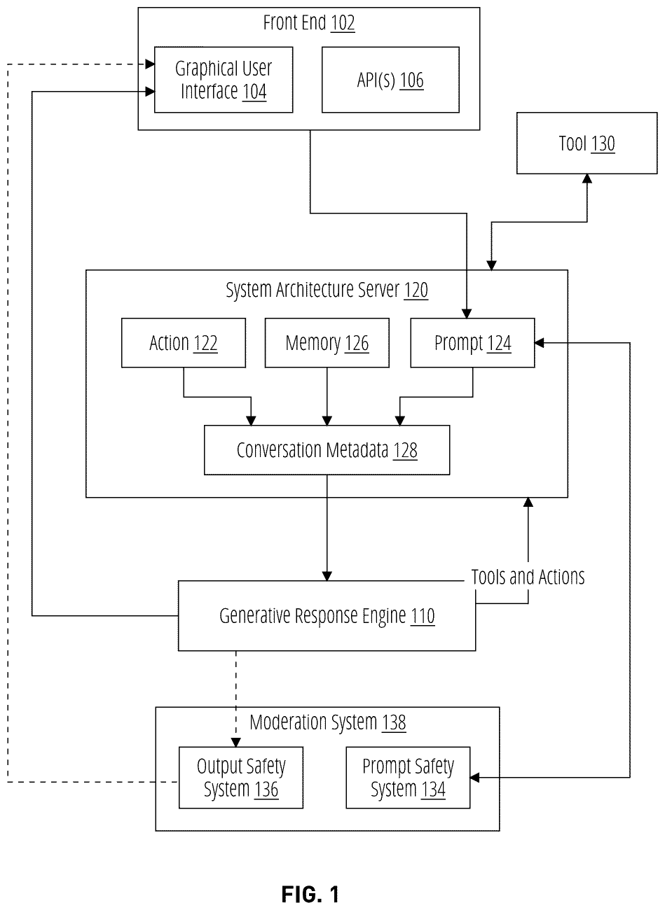

FIG. 1 illustrates an example system supporting a generative response engine during inference operations in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

Generative response engine 110 is an artificial intelligence (AI) that can generate content in response to a prompt. The prompt can be from a human or a software entity (AI or applications). The prompt is generally in natural language but could be in code, including binary. Some examples of the generative response engine can include language models that generate language, such as CHATGPT, or other models, such as DALL-E, which generates images, and SORA, which generates videos. CHATGPT, DALL-E, and SORA are all provided by OPENAI, but the generative response engine is not limited to AI provided by OPENAI. The generative response engine can also be any type of generative AI and can include AI developed using various architectures such as diffusion models and transformers (e.g., a generative pre-trained transformer) and combinations of models.

In some instances, a language model, such as CHATGPT, can receive prompts to output images, video, code, applications, etc., which it can provide by interfacing with one or more other models, as will be addressed further herein.

Users and applications can interact with generative response engine 110 through front end 102. Front end 102 serves as the interface and intermediary between the user and the generative response engine. It encompasses the graphical user interface 104 and Application Programming Interfaces (APIs) 106 that facilitate communication, input processing, and output presentation. Generally, users interact through a graphical user interface 104 that often includes a conversational interface, and applications interact through the API 106, but this is not a requirement.

The graphical user interface 104 is the platform through which users interact with generative response engine 110. It can be a web-based chat window, a mobile application, or any interface that supports data input and output. The graphical user interface 104 facilitates a conversation between the user and the generative response engine, as the user provides prompts in the graphical user interface 104 to which the generative response engine responds and presents those responses in the graphical user interface 104. In some embodiments, graphical user interface 104 presents a conversational interface, which has attributes of a conversation thread between a user account and generative response engine 110.

The graphical user interface 104 is configured to perform input handling, context management, and output presentation. The type of inputs that can be received can be relative to the specifics of generative response engine 110. But even when a model doesn't directly accept certain types of inputs, front end 102 might be able to receive different types of inputs, which can be converted to inputs that are accepted by generative response engine 110. For example, a language model is generally configured to accept text, but front end 102 can accept voice and convert it to text or accept an image and create a textual representation.

The graphical user interface 104 is also configured to maintain the context of the conversation, which allows for coherent and relevant responses. For example, graphical user interface 104 is responsible for providing the conversation thread and other relevant context accessible to front end 102 to the generative response engine along with the specific prompt to the generative response engine. In an example, a conversation between the user account and generative response engine 110 can have taken several turns (prompt, response, prompt, response, etc.). When the user account provides a further prompt, the graphical user interface 104 can provide that prompt to the generative response engine in the context of the entire conversation.

In another example front end 102 might have access to a memory 126 where facts about the user account have been stored. In some embodiments, these facts can have been identified as facts worth storing by the generative response engine and front end 102 has stored these facts at the direction of the generative response engine. Accordingly, these facts can be provided to generative response engine 110 along with a user-provided prompt so that the generative response engine has access to these facts when generating a response.

In another example, graphical user interface 104 might be configured to provide a system prompt along with a user-provided prompt. A system prompt is hidden from the user account and is used to set the behavior and guidelines for the generative response engine. It can be used to define the AI's persona, style, and constraints.

The graphical user interface 104 is also configured to display the responses from the generative response engine, which might include text, code snippets, images, or interactive elements.

In some embodiments, generative response engine 110 can provide instructions to front end 102 that instruct the graphical user interface 104 about how to display some of the output from the generative response engine. For example, the generative response engine can direct the graphical user interface 104 to present code in a code-specific format, or to present interactive graphics, or static images. In other examples, the generative response engine can direct the graphical user interface 104 to present an interactive document editor where the graphical user interface 104 can be presented with the document editor so that the user account and the generative response engine can collaborate on the document. In some embodiments, generative response engine 110 can provide instructions to front end 102 to record facts in a personalization notepad. Accordingly, the graphical user interface 104 does not always display all of the output of the generative response engine.

As noted above, front end 102 can also provide one or more application programming interfaces (API(s)) 106. APIs enable developers to integrate the generative response engine's capabilities into external applications and services. They provide programmatic access to the generative response engine, allowing for customized interactions and functionalities.

The APIs 106 can accept structured requests containing prompts, context, and configuration parameters. For example, an API can be used to provide prompts and divide the prompt into system prompts and user prompts. In some embodiments, the APIs 106 can provide specific inputs for which generative response engine 110 is configured to respond with a specific behavior. For example, an API can be used to specify that it requires an output in a particular format or structured output. For example, in the chat completion API, the API call can specify parameters for the output, such as the max length for the desired output, and specify aspects of the tone of the language used in the response. Some common APIs are for participating in a conversation (Chat Completion API), for providing a single response (Completion API), for converting text into embeddings (Embeddings API), etc. The API can also be used to indicate specific decision boundaries that generative response engine 110 might be trained to interpret. For example, the moderation API can take advantage of the generative response engine's content moderation decision-making. In the case of the moderation API and others, the API might give access to services other than the generative response engine. For example, the moderation API might be an interface to moderation system 138, addressed below.

Some other common APIs include the Fine-Tuning API, which allows developers to customize models of the generative response engine using their own datasets; the Audio and Speech APIs, which cause the generative response engine to output speech or audio; and the Image Generation API, which causes the generative response engine to output images (which might require utilizing other models).

There can also be APIs that direct the generative response engine to interface with other applications or other generative AI engines. In such cases, the specific application or AI engine might be specified, or the generative response engine might be allowed to choose another application of AI engine to utilize in response to a prompt.

In short, the graphical user interface 104 and the APIs 106 can be used to provide prompts to the generative response engine. Prompts are sometimes differentiated into prompt types. For example, a system prompt can be a hidden prompt that sets the behavior and guidelines for the generative response engine. A user prompt is the explicit input provided by the user, which may include questions, commands, or information.

Sitting in between front end 102 and generative response engine 110 is a system architecture server 120. The function of system architecture server 120 is to manage and organize the flow of data among key subsystems, enabling generative response engine 110 to generate responses that are contextually relevant, accurate, and enriched with additional information as required.

Action 122 facilitates auxiliary tasks that extend beyond basic text generation. In some embodiments, action 122 can be actions that correspond to an API 106. In some embodiments, action 122 can be agentic actions that generative response engine 110 decides to take to carry out a user's intent as described in the prompt.

Prompt 124 is the request or command provided by the user account through front end 102. In some embodiments, prompt 124 can be further supplemented by a system prompt and other information that might be included by graphical user interface 104 or API 106. In some embodiments, prompt 124 can even be modified or enhanced by generative response engine 110 as addressed further below. Additionally, as the user account provides prompts and generative response engine 110 provides responses, a conversation thread forms. As the user account provides a new prompt, this is appended to the overall conversation and added to prompt 124. Thus, a user account might think of a first user-provided message as a first prompt and a second user-provided message as a second prompt, and so on, but prompt 124 as perceived by generative response engine 110 can include a thread of user-provided messages and responses from generative response engine 110 in a multi-turn conversation. Generally, prompt 124 will include an entire conversation thread, but in some instances, prompt 124 might need to be shortened if it exceeds a maximum accepted length (generally measured by a number of tokens).

System architecture server 120 can also route prompts and response through moderation system 138, which can be separate or part of system architecture server 120. In some embodiments, prompts are provided to prompt safety system 134 before being provided to generative response engine 110. Prompt safety system 134 is configured to use one or more techniques to evaluate prompts to ensure a prompt is not requesting generative response engine 110 to generate moderated content. In some embodiments, prompt safety system 134 can utilize text pattern matching, classifiers, and/or other AI techniques.

Since prompts can evolve over time through the course of a conversation, consisting of prompts and responses, prompts can be repeatedly evaluated at each turn in the conversation.

Memory 126 can facilitate continuity and personalization in conversations. It allows the system to maintain user-specific context, preferences, or details that may inform future interactions. A memory file can be persisted data from previous interactions or sessions that provide background information to maintain continuity. In some embodiments, memory can be recorded at the instruction of generative response engine 110 when generative response engine 110 identifies a fact or data that it determines should be saved in memory because it might be useful in later conversations or sessions.

Conversation metadata 128 can aggregate data points relevant to the conversation, including user prompt 124, action 122, and memory 126. This consolidated information package serves as the input for generative response engine 110. Conversation metadata 128 can label parts of a prompt as user provided, generative response engine provided, a system prompt, memory 126, data from action 122, or tool 130 (addressed below).

The generative response engine is the core engine that processes inputs (from system architecture server 120) and generates outputs. In some embodiments, the generative response engine is a generative transformer, or autoregressive transformer, but it could utilize other architectures. In some examples, the transformer is a language model (i.e., that uses language tokens), and in some examples the transformer is multi-modal transformer that can use audio tokens (or embeddings thereof), visual tokens (or embeddings thereof), and language (or embeddings thereof) as needed.

A core feature of generative response engine 110 is to generate content in response to prompts. When generative response engine 110 is a GPT, it is configured to receive inputs from front end 102 that provide guidance on a desired output. The generative response engine can analyze the input and identify relevant patterns and associations in the data, and it has learned to generate a sequence of tokens that are predicted as the most likely continuation of the input. Generative response engine 110 generates responses by sampling from the probability distribution of possible tokens, guided by the patterns observed during its training. In some embodiments, generative response engine 110 can generate multiple possible responses before presenting the final one. Generative response engine 110 can generate multiple responses based on the input, and these responses are variations that generative response engine 110 considers potentially relevant and coherent.

In some embodiments, generative response engine 110 can evaluate generated responses based on certain criteria. These criteria can include relevance to the prompt, coherence, fluency, and sometimes adherence to specific guidelines or rules, depending on the application. Based on this evaluation, generative response engine 110 can select the most appropriate response. This selection is typically the one that scores highest on the set criteria, balancing factors like relevance, informativeness, coherence, and content moderation instructions/training.

In some embodiments, an instruction provided by an API 106, a system prompt, or a decision made by generative response engine 110 can cause generative response engine 110 to interpret a prompt and re-write it or improve the prompt for a desired purpose. For example, generative response engine 110 can determine to take a prompt to make a picture and enhance the prompt to yield a better picture. In these instances, generative response engine 110 can generate its own prompts, which can be provided to a tool 130 or provided to generative response engine 110 to yield a better output response than the original prompt might have.

Generative response engine 110 can also do more than generate content in response to a prompt. In some embodiments, generative response engine 110 can utilize decision boundaries to determine the appropriate course of action based on the prompt. In some examples, a decision boundary might be used to cause the generative response engine to recognize that it is being asked to provide a response in a particular format such that it will generate its response constrained by the particular format. In some examples, a decision boundary can cause the model to refuse to generate a responsive output if the decision is that the responsive output would violate a moderation policy. In some examples, the decision boundary might cause the generative response engine to recognize that it needs to interface with another AI model or application to respond to the prompt. For example, when the generative response engine is a language model, it might recognize that it is being asked to output an image, and therefore, it needs to interface with a model that can output images to provide a response to the prompt. In another example, the prompt might request a search of the Internet before responding. The generative response engine can use a decision boundary to recognize that it should conduct a search of the Internet and use the results of that search in responding to the prompt. In another example, the prompt might request that the generative response engine take an agentic action on behalf of the user by interacting with a third-party service (e.g., book a reservation for me at . . .), and the generative response engine can utilize a decision boundary to recognize that it needs to plan steps to locate the third-party service, contact the third-party service, and interact with the third-party service to complete the task and then report back to the user that the action has been completed.

When generative response engine 110 determines that it should take an agentic action on behalf of the user or it should call a tool to aid in providing a quality response to the user account, generative response engine 110 might call a tool 130 or cause an action 122 to be performed. As indicated above, tools 130 can include internet browsers, editors such as code editors, other AI tools etc. Actions 122 are actions that generative response engine 110 can cause to be performed, perhaps using tool 130. As used herein actions 122 should be considered to cover a broad array of actions that generative response engine 110 can perform with or without tools 130. Tools 130 are considered to cover a wide variety of services and software that encompass tools such as a computer operating system such that generative response engine 110 can control the computer operating system on the user's behalf, to robotic actuators, to search browsers and specific applications.

Additionally, generative response engine 110 can also generate portions of responses that are not displayed to the user. For example, generative response engine 110 can direct front end 102 to provide specific behaviors, such as directions for how to present the response from generative response engine 110 to the user account. In another example, generative response engine 110 can provide response portions dictated by an API, where portions of the response to the API might be for the consumption of the calling application but not for presentation to the end user.

In some embodiments, the output of generative response engine can be further analyzed by output safety system 136. While generative response engine 110 can perform some of its own moderation, there can be instances where it is desired to have another service review outputs for compliance with the moderation policy. The use of dashed lines in FIG. 1 differentiates a path using output safety system 136 and not using output safety system 136.

While FIG. 1 shows responses being provided back to front end 102 directly, in some embodiments, the responses might be returned by way of system architecture server 120.

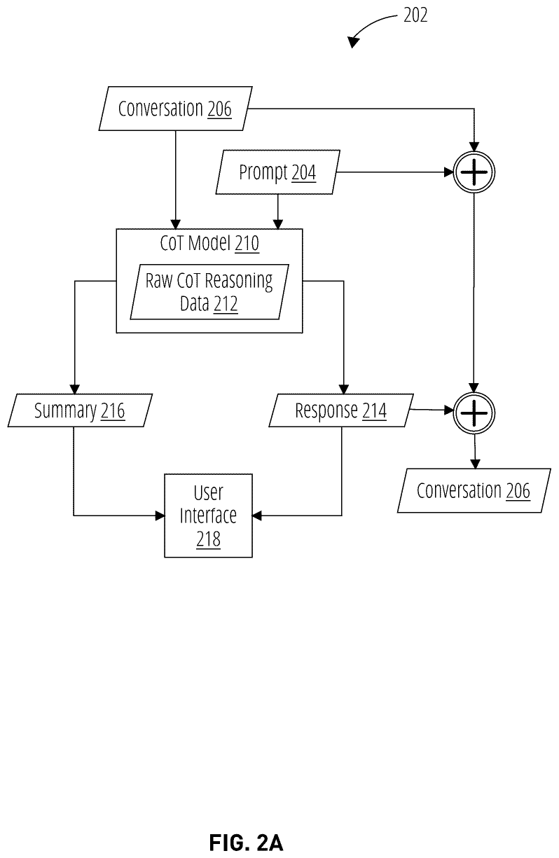

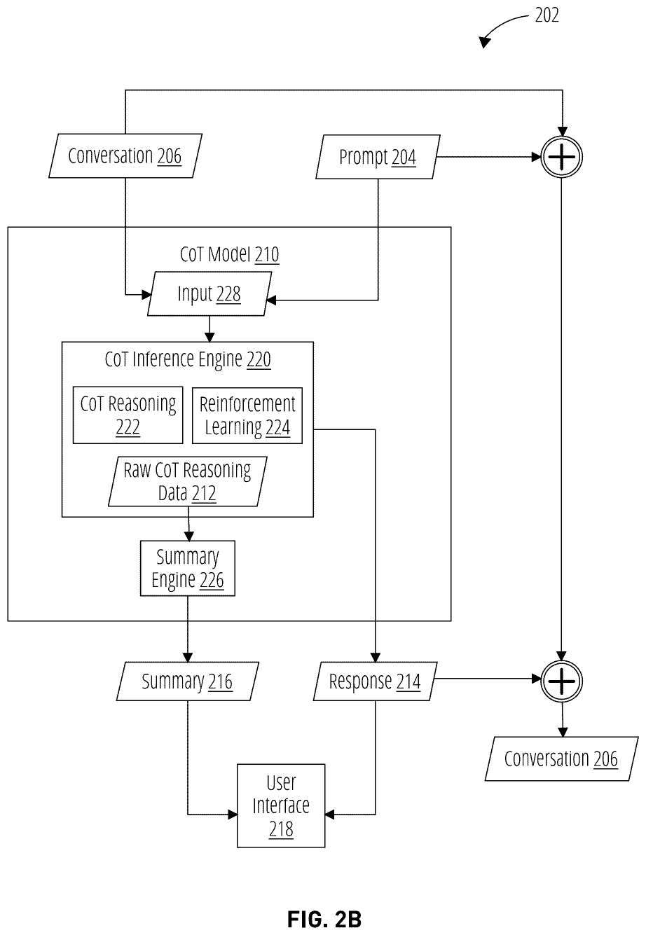

FIG. 2A and FIG. 2B illustrates a chain-of-thought (CoT) reasoning system (e.g., CoT system 202) that includes CoT model 210, according to certain non-limiting examples. In FIG. 2A, CoT model 210 generates response 214 based on prompt 204. CoT model 210 can also use conversation thread 206 to provide context for the prompt. After receiving prompt 204, conversation thread 206 is extended to include the prompt, e.g., the new conversation thread is conversation thread 206 concatenated with prompt 204.

Rather than immediately streaming response 214, CoT model 210 undertakes an internal conversation in which an inference engine develops a multi-step reasoning process. This internal conversation and the resulting multi-step reasoning process are captured in raw CoT reasoning data 212, which can also be referred to as reasoning tokens. The combination of prompt 204 and conversation thread 206 can be referred to as input tokens, and response 214 can be referred to as output tokens. As CoT model 210 continues to develop the internal conversation continues, chunks of raw CoT reasoning data 212 corresponding to steps in the multi-step reasoning process can be summarized (e.g., summary 216) and presented to the user in a user interface (e.g., UI 218). The summaries of the steps can be presented while the multi-step reasoning process develops.

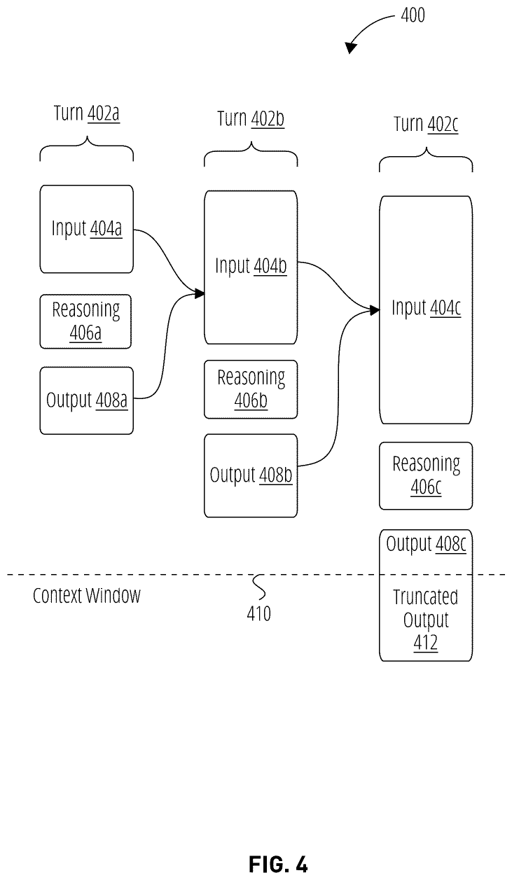

In addition to summary 216, CoT model 210 also generates response 214. According to certain non-limiting examples, response 214 is generated by applying the multi-step reasoning process that is developed in raw CoT reasoning data 212. Response 214 is concatenated to conversation thread 206 and provides part of the context for responding to future prompts, as illustrated in FIG. 4. According to certain non-limiting examples, CoT model 210 can begin generating response 214 before CoT model 210 has finished generating raw CoT reasoning data 212. Alternatively, CoT model 210 can begin generating response 214 after CoT model 210 has finished generating raw CoT reasoning data 212. Response 214 can be generated by performing the multi-step reasoning process generated by raw CoT reasoning data 212, whereas summary 216 can summarize of the steps of the multi-step reasoning process.

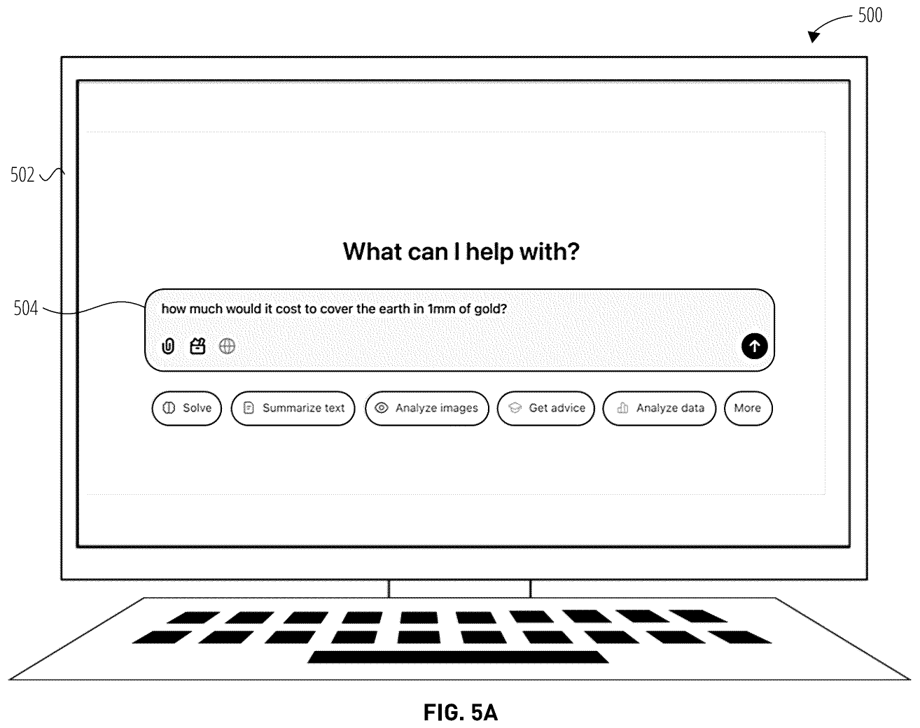

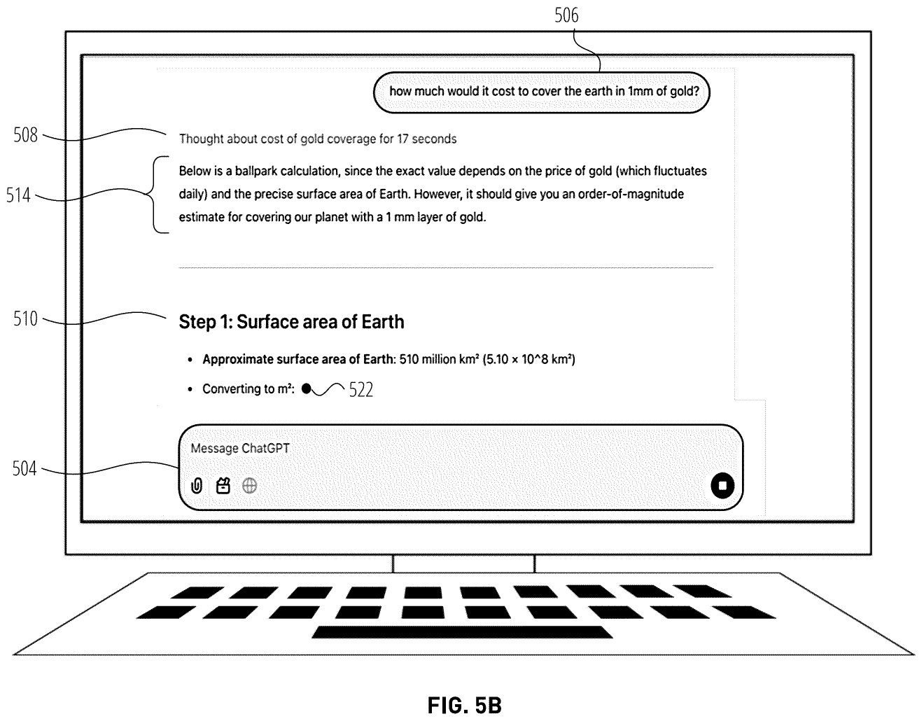

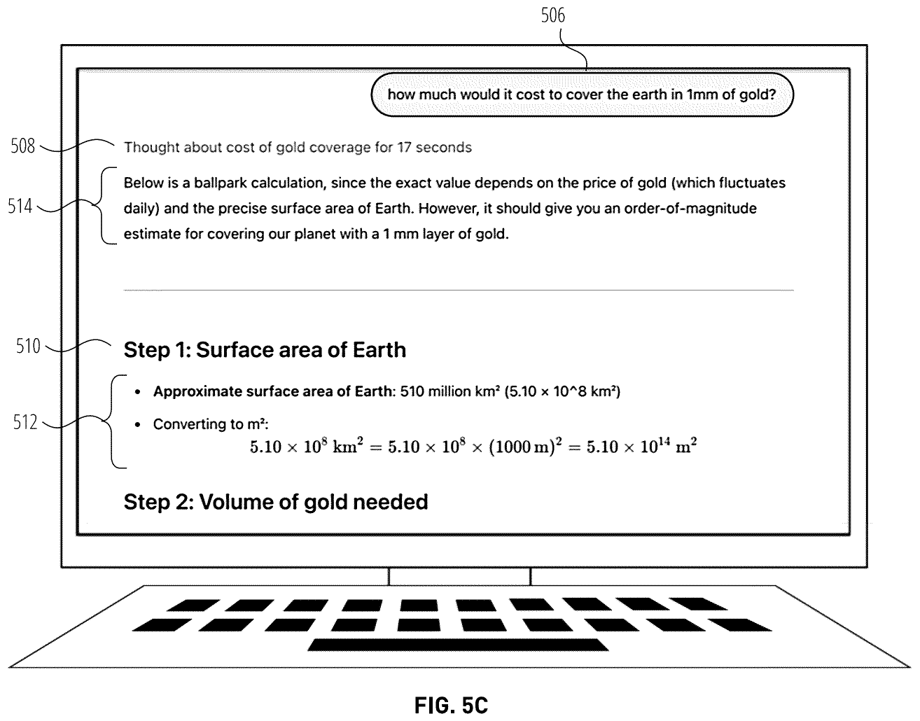

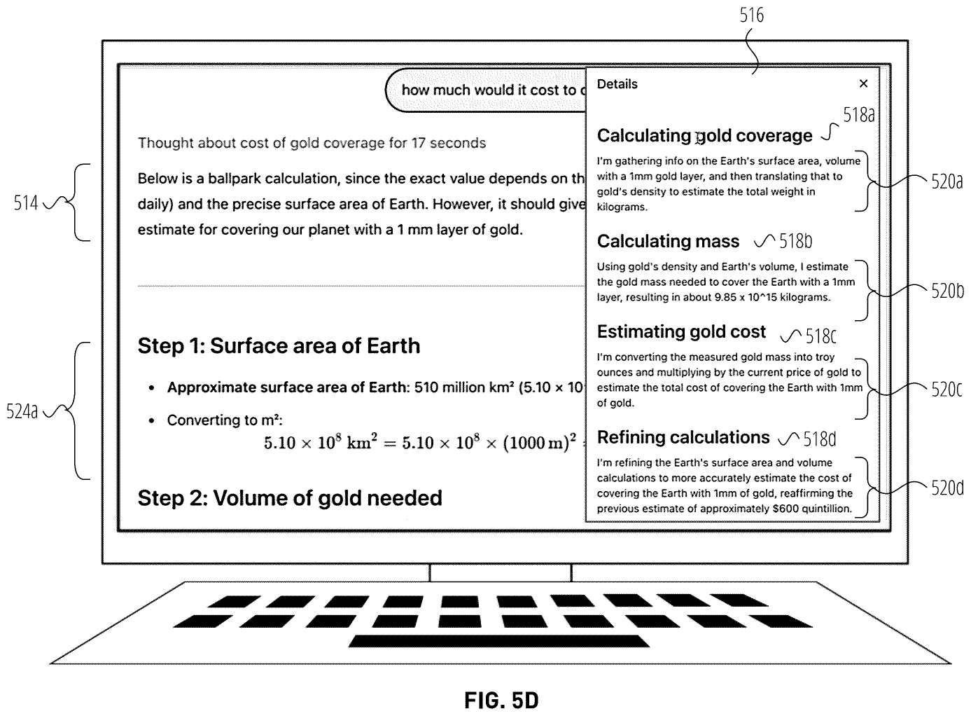

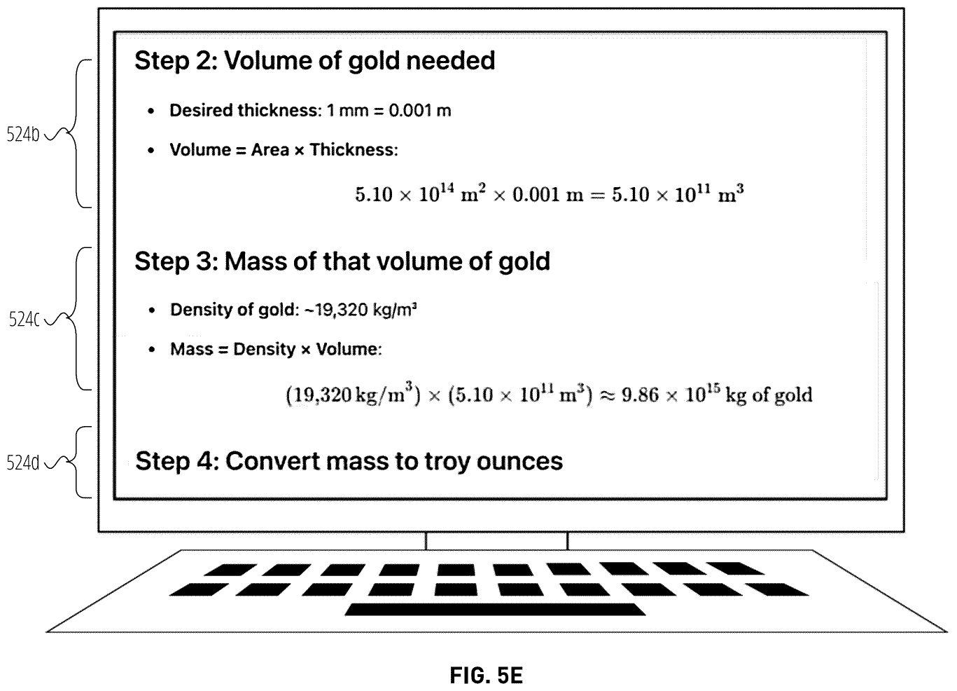

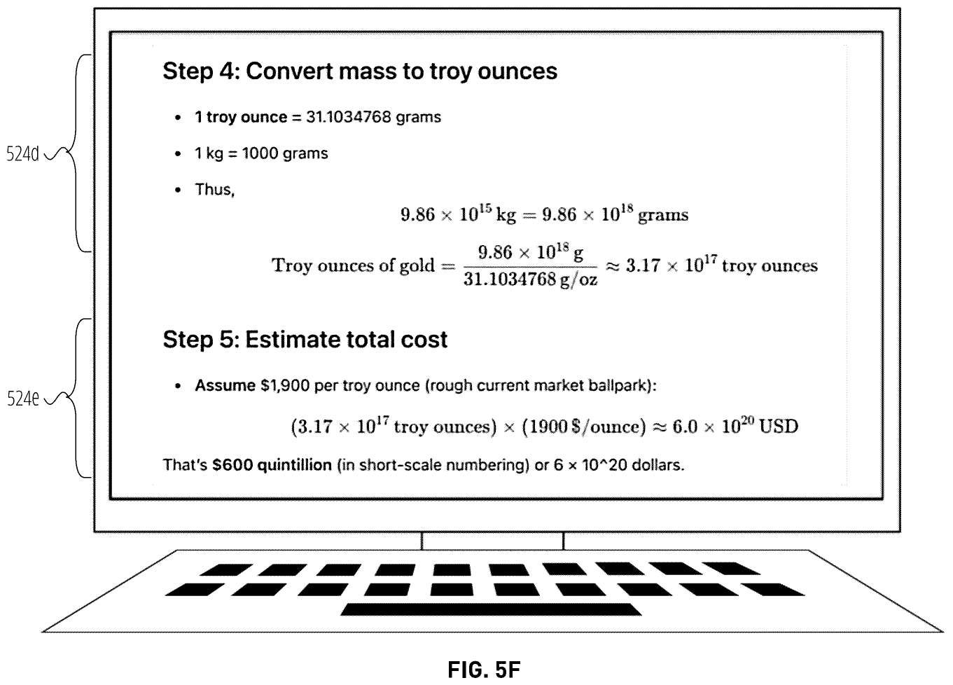

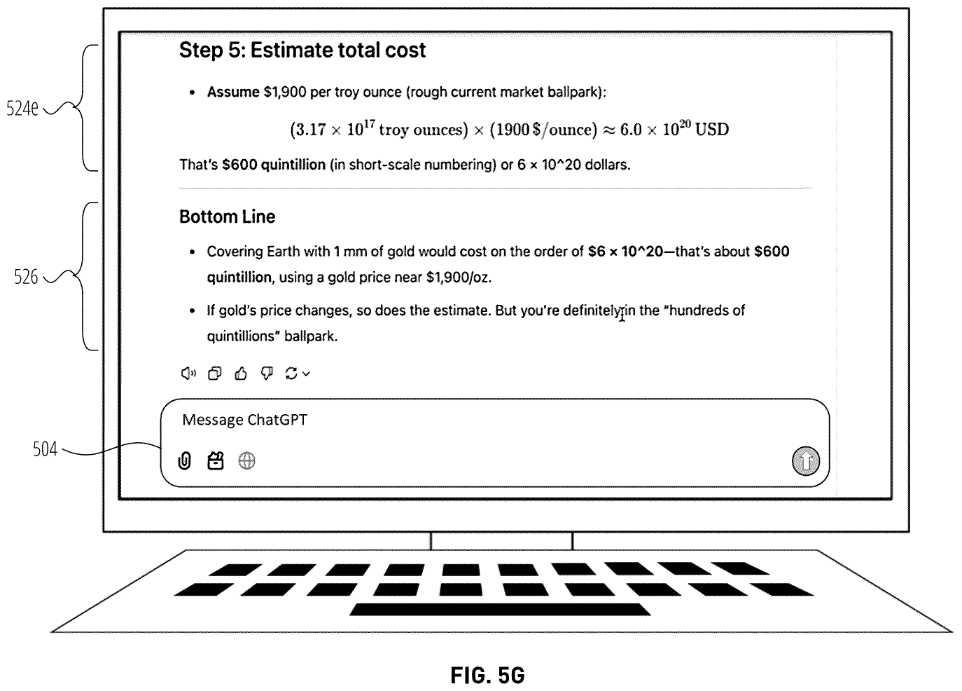

The internal conversation can include trying different approaches to responding to the prompt, evaluating the effectiveness of one or more approaches to responding to the prompt, and backtracking and trying a different approach due to the current approach being ineffective for responding to the prompt. According to certain non-limiting examples, when CoT model 210 backtracks or modifies the multi-step reasoning process, summary 216 and response 214 can be updated to reflect the modified multi-step reasoning process. According to certain non-limiting examples, the generation of summary 216 and response 214 can be delayed until the multi-step reasoning process represented by raw CoT reasoning data 212 is sufficiently mature that the initial steps of the multi-step reasoning process are unlikely to change or until the current multi-step reasoning process is likely to provide an effective response. As illustrated in FIG. 5B the amount of time spent reasoning (e.g., generating raw CoT reasoning data 212) before generating response 214 can be many seconds.

FIG. 2B illustrates a non-limiting example of CoT model 210. For example, prompt 204 can be received through UI 218, as illustrated in FIG. 5A.

CoT model 210 can perform a process in which CoT inference engine 220 of CoT model 210 conducts an internal conversation to generate raw CoT reasoning data 212, which can provide a multi-step reasoning process for responding to the prompt. The generation of raw CoT reasoning data 212 can be realized using CoT reasoning 222 and reinforcement learning 224. After sufficient time has been spent by CoT inference engine 220 to develop the multi-step reasoning process, CoT inference engine 220 uses raw CoT reasoning data 212 to generate response 214. Further, chunks of raw CoT reasoning data 212 corresponding to steps in the multi-step reasoning process can be passed to summary engine 226 (e.g., an autoregressive language model) to generate summary 216. Summaries for the initial steps of the multi-step reasoning process can be generated simultaneously with CoT inference engine 220 continuing to reason about later steps of the multi-step reasoning process and/or generate response 214 based on raw CoT reasoning data 212.

CoT inference engine 220 can use a combination of reinforcement learning (e.g., reinforcement learning 224) and a chain-of-thought reasoning engine (e.g., CoT reasoning 222). Through reinforcement learning, CoT model 210 learns to refine its thinking process, exploring different strategies, recognizing mistakes, and adapting its approach to arrive at the most accurate and logical solution. CoT model 210 also uses chain-of-thought reasoning, which breaks down complex problems into smaller, more manageable components. chain-of-thought reasoning allows CoT inference engine 220 to reason about the prompt before answering the prompt. Further, by explicitly outlining the reasoning process, CoT inference engine 220 can identify potential errors early on and increase the likelihood of arriving at the correct solution. In summary 216, CoT system 202 provides the user a step-by-step summarization of the reasoning process, which provides transparency and provides the user a path to double-check and verify the result/response. Summary 216 has the benefits of: (1) building trust in how CoT system 202 thinks and approaches problems; (2) providing the user a useful glimpse into what is happening in CoT system 202 before they get a final answer (e.g., response 214); and (3) offering a way to verify the reasoning process of CoT model 210 and/or pinpoint potential mistakes.

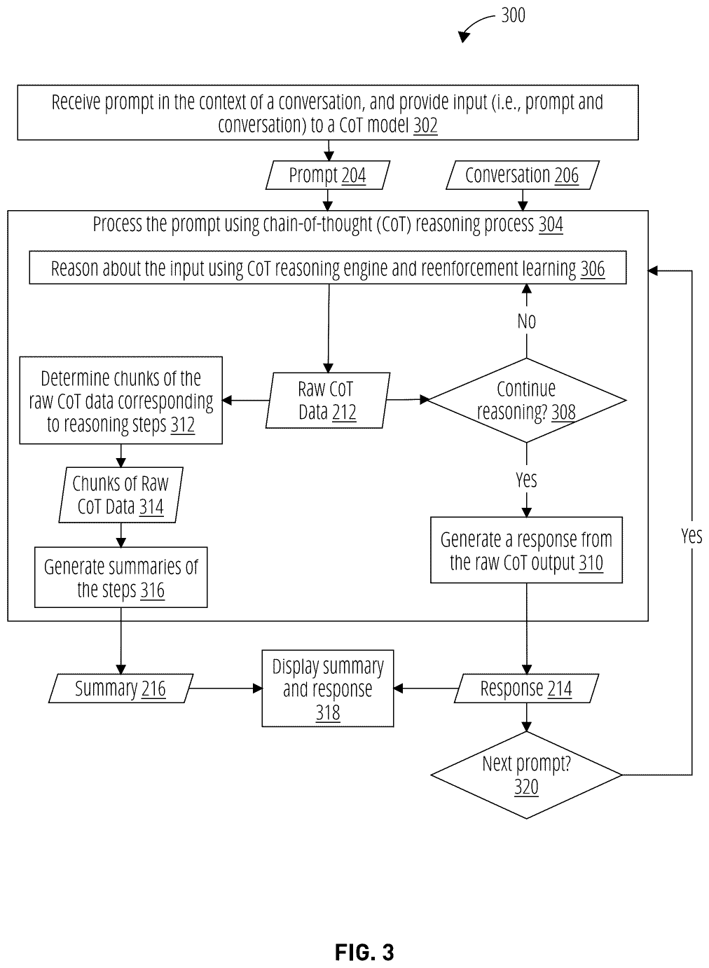

FIG. 3 illustrates an example method 300 for generating responses to prompts using chain-of-thought reasoning. Although the example method 300 depicts a particular sequence of operations, the sequence may be altered without departing from the scope of the present disclosure. For example, some of the operations depicted may be performed in parallel or in a different sequence that does not materially affect the function o method 300. In other examples, different components of an example device or system that implements method 300 may perform functions at substantially the same time or in a specific sequence.

According to some examples, step 302 of the method includes receiving a prompt in the context of a conversation and providing the prompt and the preceding conversation (e.g., to provide context for the prompt) to a chain-of-thought (CoT) model. For example, a prompt received in a user interface (e.g., UI 218 in the CoT system 202 illustrated in FIG. 2A) may receive prompt 204 in the context of conversation thread 206, and provide input 228 (i.e., prompt 204 together with conversation thread 206) to CoT model 210.

According to some examples, step 304 of the method includes processing the prompt using chain-of-thought (CoT) reasoning process. For example, CoT model 210 illustrated in FIG. 2B may process prompt 204 using the CoT reasoning process as discussed above with reference to FIG. 2A and/or FIG. 2B.

According to certain non-limiting examples, reasoning models are language models trained with reinforcement learning to perform complex reasoning. Reasoning models think before they answer, producing a long internal chain of thought before responding to the user. Reasoning models can excel in complex problem solving, coding, scientific reasoning, and multi-step planning for agentic workflows. CoT reasoning models can be slower and more expensive than other autoregressive models. CoT reasoning models, however, can generate better responses for complex tasks and generalize better across domains.

CoT reasoning can use a method of problem-solving or decision-making where each step is logically connected to the next. CoT reasoning can apply a process of explicitly thinking through intermediate steps or breaking down complex problems into smaller, manageable parts. This technique is useful for tackling problems that depend on deeper or more systematic thinking.

In the context of artificial intelligence, CoT reasoning can make decisions or solve problems using a step-by-step manner, rather than just jumping to a final answer. This approach can improve the accuracy and transparency of AI decision-making, as it provides insight into the reasoning process behind an answer. For example, if an AI is asked to solve a math problem, rather than simply providing the final answer, chain-of-thought reasoning would have the AI show each step of its calculation, explaining how it arrived at the solution. This method can also help reduce errors and improve the interpretability of AI systems.

According to some examples, step 306 of the method includes processing the input using an inference engine to generate an output. For example, CoT inference engine 220 illustrated in FIG. 2B may process input 228 to generate raw CoT reasoning data 212.

According to some examples, decision step 308 of the method inquires whether the CoT process has reached its end or the CoT reasoning should continue. When the CoT process has not ended, method 300 continues from decision step 308 to step 306. When the CoT process has reached its end, CoT model 210 outputs raw CoT reasoning data 212, and method 300 continues from decision step 308 to step 310.

According to some examples, step 310 of the method includes generating a response from the raw CoT data. For example, CoT model 210 illustrated in FIG. 2A may generate response 214 from raw CoT reasoning data 212.

According to some examples, step 312 of the method includes determining chunks of the raw CoT data corresponding to reasoning steps. For example, CoT inference engine 220 or summary engine 226 illustrated in FIG. 2B may determine chunks of raw CoT data 314 corresponding to reasoning steps that were developed in raw CoT reasoning data 212.

According to some examples, step 316 of the method includes generating summaries of the respective steps of the multi-step reasoning process. For example, summary engine 226 processes chunks of raw CoT data 314, which represent respective steps of the multi-step reasoning process, to generate a summary of the multi-step reasoning process. Summary 216 can be generated step by step as the respective chunks become available. For example, if the reasoning process takes several minutes, the initial parts of summary 216 can be generated and displayed in UI 218 within the first minute of reasoning to provide the user reassurance and updates regarding the state of the reasoning process.

According to some examples, step 318 of the method includes displaying results and optionally receiving an additional, follow-on prompt. For example, UI 218 illustrated in FIG. 2B may display results. Additionally, UI 218 may receive an additional prompt, which continues the conversation thread with the CoT system 200 by initiating another turn of the conversation.

According to some examples, decision step 320 of the method inquires whether another prompt was received. When another prompt is received, method 300 can continue from decision step 320 to step 304.

FIG. 4 illustrates an example of a CoT work flow (e.g., chain-of-thought flow 400). In the illustrated non-limiting examples, three turns 402 are shown (e.g., turn 402a, turn 402b, and turn 402c). In turn 402a, CoT system 202 receives an input (e.g., input tokens 404a, such as input 228, which can include conversation thread 206 and prompt 204) and generates reasoning tokens 406a (e.g., the raw CoT reasoning data 212) and output tokens 408a (e.g., response 214). A summary can be generated based on reasoning tokens 406a. Reasoning tokens 406a, however, are not provided to the user and are not added to the conversational thread or otherwise carried over to the next turn in the conversation. That is, after the turn is complete, reasoning tokens 406a are effectively discarded, and the conversation thread for the next turn (e.g., input tokens 404b) includes only input tokens 404a combined with output tokens 408a to provide the context for a follow-on prompt. The combination of input tokens 404a, output tokens 408a, and tokens representing the follow-on prompt becomes the input tokens 404b for turn 402b.

In the second turn (e.g., turn 402b), CoT model 210 receives input tokens 404b and generates reasoning tokens 406b and output tokens 408b based on input tokens 404b. Again the reasoning tokens (e.g., reasoning tokens 406b) are discarded and the input and output tokens (e.g., input tokens 404b and output tokens 408b) are combined with another follow-on prompt to create the input (e.g., input tokens 404c) for the next turn (e.g. turn 402c). Because the reasoning tokens are not visible, the total number of tokens may be different (e.g., larger) than the user is expecting.

In the third turn (e.g., turn 402c), CoT model 210 receives input tokens 404c, and, in response, generates reasoning tokens 406c and output tokens 408c. In this case, the total number of tokens exceeds a predefined length for context window 410 (e.g., 128 k tokens) and the tokens exceeding context window 410 can be truncated (e.g., truncated output 412).

According to certain non-limiting examples, a user can set an effort parameter that guides how much reasoning CoT model 210 performs before proceeding to generate response 214. The effort parameter can be used to adjust the tradeoff between speed/cost and reasoning accuracy. For example, the effort parameter can provide CoT model 210 guidance on how many reasoning tokens it should generate before creating a response to the prompt. According to certain non-limiting examples, the user can specify one of “low,” “medium,” or “high” for the effort parameter, where a designation of “low” for the effort parameter will favor speed and economical token usage, and a designation of “high” for the effort parameter will favor more complete reasoning at the cost of more tokens generated and slower responses.

Reasoning models (e.g., CoT model 210) can use reasoning tokens in addition to input and output tokens. The models use these reasoning tokens to break down their understanding of the prompt and consider multiple approaches to generating a response. After generating reasoning tokens, the model produces an answer as visible completion tokens, and discards the reasoning tokens from its context. FIG. 4 illustrates an example of a multi-step conversation between a user and an assistant. Input and output tokens from each step are carried over, while reasoning tokens are discarded.

FIGS. 5A-5G illustrate respective views of a user interface on computing system 500. FIG. 5A shows computing system 500 having display 502 on which the user interface is displayed, including text entry field 504 in which a prompt can be entered (e.g., prompt 204).

FIG. 5B illustrates an example of the user interface shortly after the prompt has been entered and CoT system 202 begins processing the prompt 506. Time report 508 shows how long the reasoning process took. Prefatory statement 514 is the opening text of the response (e.g., response 214). Step title 510 is the title of the first step of the multi-step reasoning process that generates the response. Progress indicator 522 shows the current progress for generating the response. Text entry field 504 provides a user-interaction component where a user can enter a follow-on prompt. summary engine 226 can be an autoregressive machine learning (ML) model that generates one token at a time, such that each new token adds to the response at progress indicator 522.

FIG. 5C illustrates an example of the user interface upon completion of the response. Each step in the response can include a title (e.g. step title 510) and a body (e.g., step body 512). According to certain non-limiting examples, summary 216 can be accessed by clicking on time report 508.

FIG. 5d illustrates an example of the user interface after time report 508 has been clicked to access summary 216. Summary 216 can be displayed in a window of the user interface (e.g., summary 516). For each of the steps in the reasoning process, summary 516 includes a title for the step (e.g., title 518a, title 518b, title 518c, and title 518d) and a description for the step (e.g., description 520a, description 520b, description 520c, and description 520d). The steps in summary 216 (e.g., in summary 516) are related to the steps in response 214 (e.g., analysis step 524a) but there is not necessarily a one-to-one correspondence. In the example shown in FIGS. 5A-5G, there are five steps in the response and only four steps in the summary.

FIG. 5E illustrates scrolling down the response to show the second, third, and fourth analysis steps (e.g., analysis step 524b, analysis step 524c, and analysis step 524d).

FIG. 5F illustrates scrolling farther down the response to show the fourth and fifth analysis steps (e.g., analysis step 524d and analysis step 524e).

FIG. 5F illustrates scrolling even farther down the response to show the fifth analysis step and the conclusion of the response (e.g., analysis step 524e and conclusion 526) and text entry field 504. Text entry field 504 can be used to enter a follow-on prompt to generate an additional response.

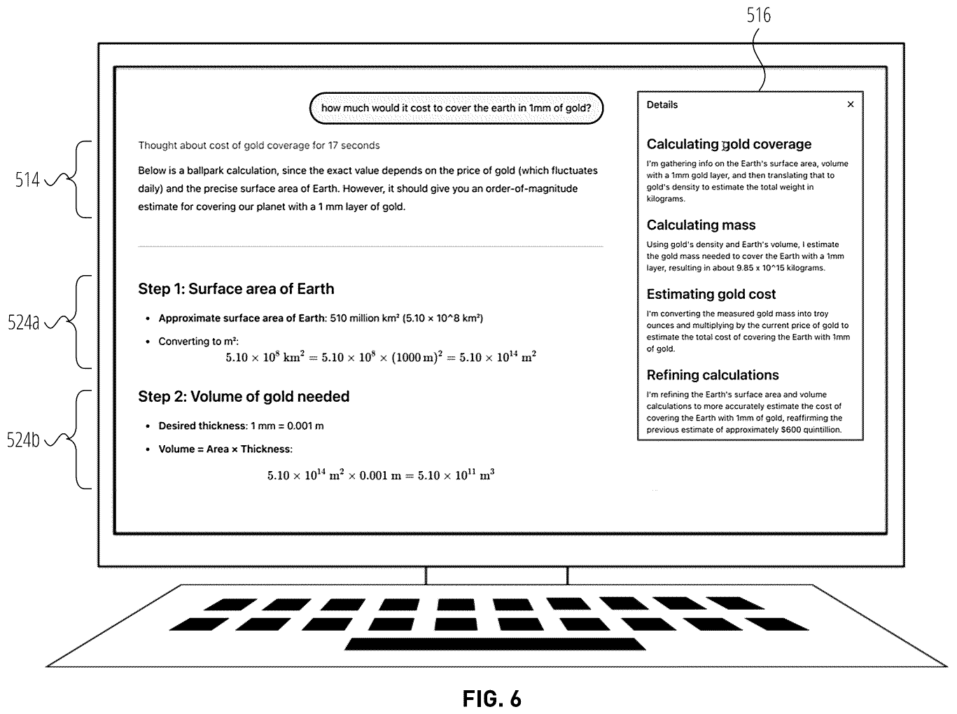

FIG. 6 illustrates an example in which the response and the summary of the CoT reasoning are displayed side-by-side, rather than with summary 516 superimposed over and covering part the response

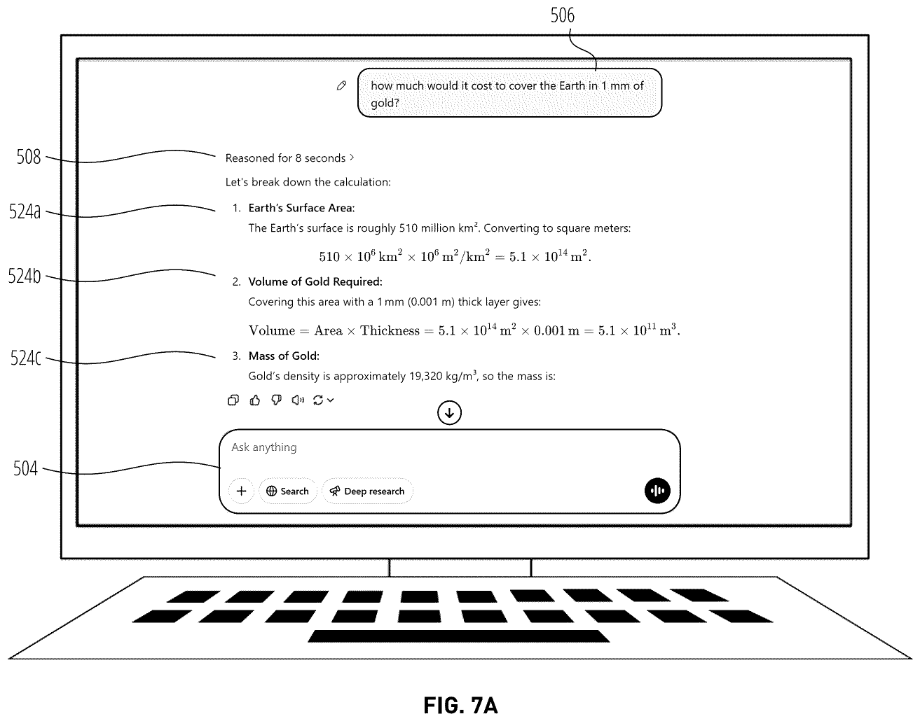

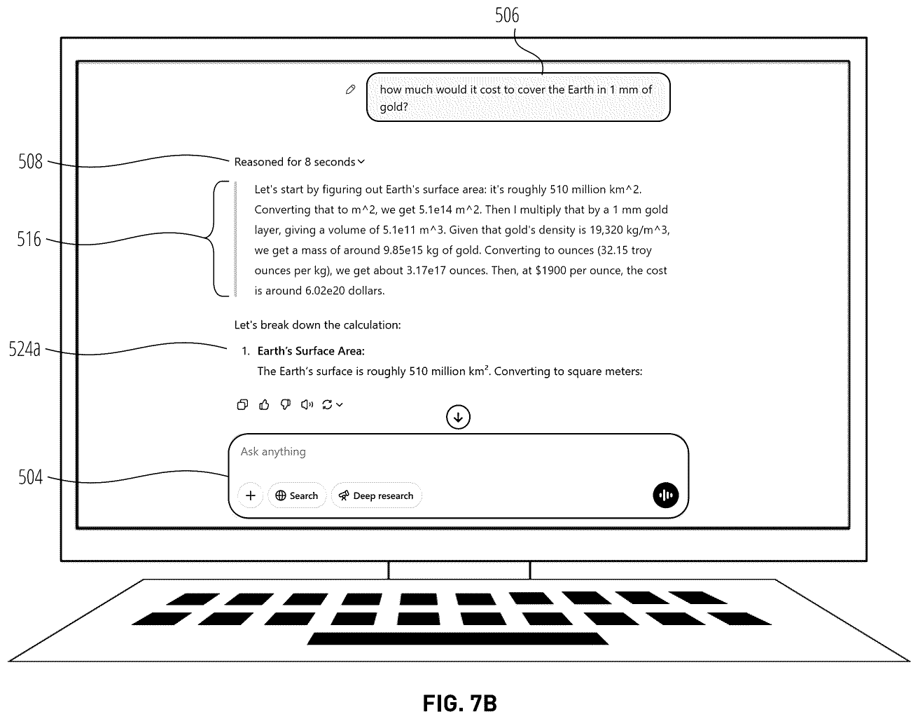

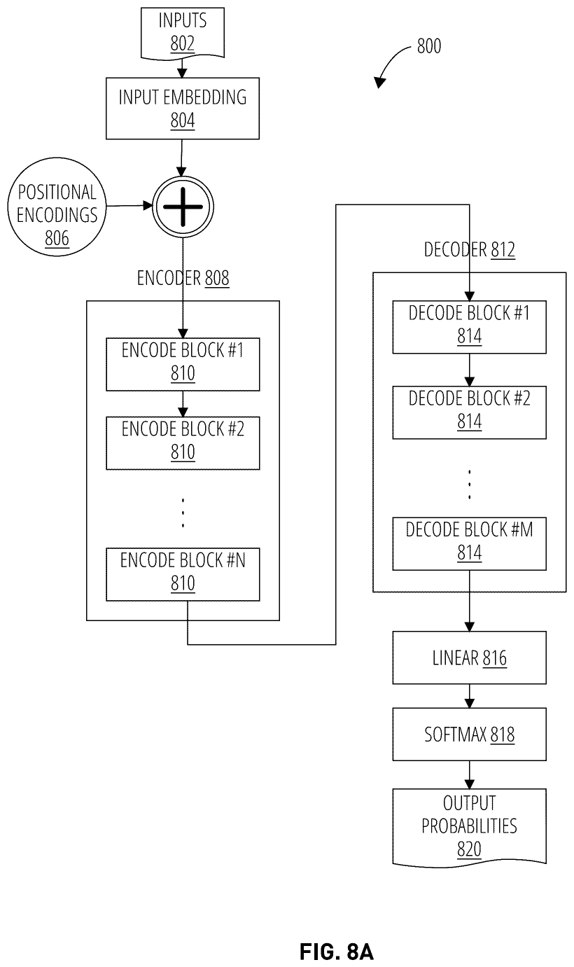

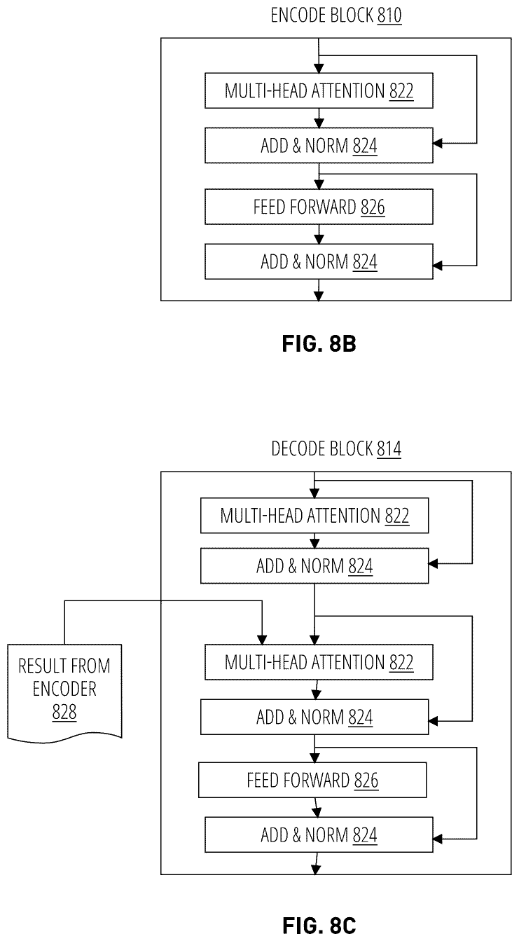

FIG. 7A and FIG. 7B illustrates an example of the user interface when the summary 516 is provided in line with the response, rather than in a separate panel to the side of the response. FIG. 7A illustrates an example of the user interface after the prompt has been entered and CoT system 202 has completed the CoT reasoning and response 214 has been generated. Time report 508 shows how long the reasoning process took. Text entry field 504 provides a user-interaction component where a user can enter another prompt. The first part of response 214 is provided as analysis step 524a, analysis step 524b, and analysis step 524c. The rest of the response can be viewed by scrolling down the window. Summary 216 can be viewed by selecting time report 508.

FIG. 7B show the user interface after selecting time report 508. Here, summary 516 is displayed inline with the response, in contrast to FIG. 5D and FIG. 6 in which summary 516 is displayed in a panel that is offset from the displayed response.

FIG. 8A, FIG. 8B, and FIG. 8C illustrates an example transformer architecture in accordance with some embodiments of the present technology. Examples of machine learning (ML) models that use a transformer neural network (e.g., transformer architecture 800) can include, e.g., generative pretrained transformer (GPT) models and Bidirectional Encoder Representations from Transformer (BERT) models. The transformer architecture 800, which is illustrated in FIG. 8A, FIG. 8B, and FIG. 8C, includes inputs 802, input embedding block 804, positional encodings 806, encoder 808 including encode blocks 810, decoder 812 including decode blocks 814, linear block 816, softmax block 818, and output probabilities 820.

Input embedding block 804 is used to provide representations for words. For example, embedding can be used in text analysis. According to certain non-limiting examples, the representation is a real-valued vector that encodes the meaning of the word in such a way that words that are closer in the vector space are expected to be similar in meaning. Word embeddings can be obtained using language modeling and feature learning techniques, where words or phrases from the vocabulary are mapped to vectors of real numbers. According to certain non-limiting examples, the input embedding block 804 can be learned embeddings to convert the input tokens and output tokens to vectors of dimension that have the same dimension as the positional encodings, for example.

Positional encodings 806 provide information about the relative or absolute position of the tokens in the sequence. According to certain non-limiting examples, positional encodings 806 can be provided by adding positional encodings to the input embeddings at the inputs to the encoder 808 and decoder 812. The positional encodings have the same dimension as the embeddings, thereby enabling a summing of the embeddings with the positional encodings.

There are several ways to realize the positional encodings, including learned and fixed. For example, sine and cosine functions having different frequencies can be used. That is, each dimension of the positional encoding corresponds to a sinusoid. Other techniques of conveying positional information can also be used, as would be understood by a person of ordinary skill in the art. For example, learned positional embeddings can instead be used to obtain similar results. An advantage of using sinusoidal positional encodings rather than learned positional encodings is that doing so allows the model to extrapolate to sequence lengths longer than the ones encountered during training.

Encoder 808 can use stacked self-attention and point-wise, fully connected layers. Encoder 808 can be a stack of N identical layers (e.g., N=6), and each layer can be an encode block, as illustrated by encode block 810 shown in FIG. 8B. Each encode block 810 has two sub-layers: (i) a first sub-layer has a multi-head attention block 822 and (ii) a second sub-layer has a feed forward block 826, which can be a position-wise fully connected feed-forward network. The feed forward block 826 can use a rectified linear unit (ReLU).

Encoder 808 uses a residual connection around each of the two sub-layers, followed by an add & norm block 824, which performs normalization. For example, the output of each sub-layer can be LayerNorm(x+Sublayer(x)). To facilitate these residual connections, all sub-layers in the model, as well as the embedding layers, produce output data having a same dimension.

Similar to encoder 808, decoder 812 uses stacked self-attention and point-wise, fully connected layers. Decoder 812 can also be a stack of M identical layers (e.g., M=6), and each layer can be a decode block, as illustrated by decode block 812 shown in FIG. 8B. In addition to the two sub-layers (i.e., the sublayer with multi-head attention block 822 and the sub-layer with feed forward block 826) found in encode block 810, decode block 814 can include a third sub-layer, which performs multi-head attention over the output of the encoder stack. Similar to encoder 808, decoder 812 uses residual connections around each of the sub-layers, followed by layer normalization. Additionally, the sub-layer with multi-head attention block 822 can be modified in the decoder stack to prevent positions from attending to subsequent positions. This masking, combined with the fact that the output embeddings are offset by one position, can ensure that the predictions for position i can depend only on the known output data at positions less than i.

Linear block 816 can be a learned linear transformation. For example, when transformer architecture 800 is being used to translate from a first language into a second language, linear block 816 can project the output from the last decode softmax block 818 into word scores for the second language (e.g., a score value for each unique word in the target vocabulary) at each position in the sentence. For instance, if the output sentence has seven words and the provided vocabulary for the second language has 10,000 unique words, then 10,000 score values are generated for each of those seven words. The score values indicate the likelihood of occurrence for each word in the vocabulary in that position of the sentence.

Softmax block 818 then turns the scores from linear block 816 into output probabilities 820 (which add up to 1.0). In each position, the index provides for the word with the highest probability and then maps that index to the corresponding word in the vocabulary. Those words then form the output sequence of transformer architecture 800. The softmax operation is applied to the output from linear block 816 to convert the raw numbers into output probabilities 820 (e.g., token probabilities).

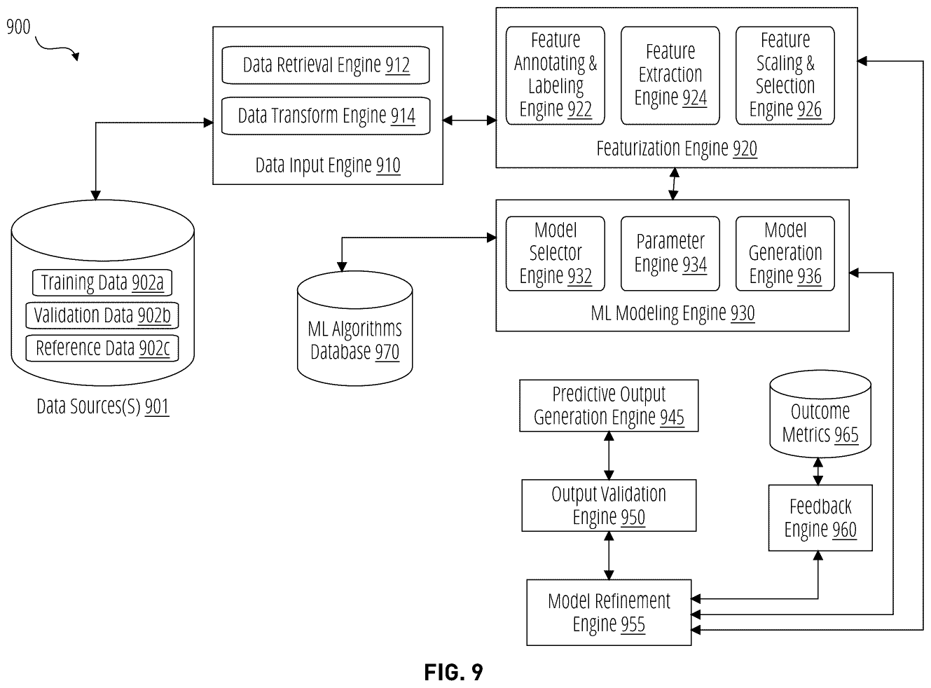

FIG. 9 is a block diagram illustrating an example machine learning platform for implementing various aspects of this disclosure in accordance with some aspects of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 900 may include data input engine 910 that can further include data retrieval engine 912 and data transform engine 914. Data retrieval engine 912 may be configured to access, interpret, request, or receive data, which may be adjusted, reformatted, or changed (e.g., to be interpretable by another engine, such as data input engine 910). For example, data retrieval engine 912 may request data from a remote source using an API. Data input engine 910 may be configured to access, interpret, request, format, re-format, or receive input data from data sources(s) 901. For example, data input engine 910 may be configured to use data transform engine 914 to execute a re-configuration or other change to data, such as a data dimension reduction. In some embodiments, data sources(s) 901 may be associated with a single entity (e.g., organization) or with multiple entities. Data sources(s) 901 may include one or more of training data 902a (e.g., input data to feed a machine learning model as part of one or more training processes), validation data 902b (e.g., data against which at least one processor may compare model output with, such as to determine model output quality), and/or reference data 902c. In some embodiments, data input engine 910 can be implemented using at least one computing device. For example, data from data sources(s) 901 can be obtained through one or more I/O devices and/or network interfaces. Further, the data may be stored (e.g., during execution of one or more operations) in a suitable storage or system memory. Data input engine 910 may also be configured to interact with a data storage, which may be implemented on a computing device that stores data in storage or system memory.

System 900 may include featurization engine 920. Featurization engine 920 may include feature annotating & labeling engine 922 (e.g., configured to annotate or label features from a model or data, which may be extracted by feature extraction engine 924), feature extraction engine 924 (e.g., configured to extract one or more features from a model or data), and/or feature scaling & selection engine 926 Feature scaling & selection engine 926 may be configured to determine, select, limit, constrain, concatenate, or define features (e.g., AI features) for use with AI models.

System 900 may also include machine learning (ML) ML modeling engine 930, which may be configured to execute one or more operations on a machine learning model (e.g., model training, model re-configuration, model validation, model testing), such as those described in the processes described herein. For example, ML modeling engine 930 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 902a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 930 may include model selector engine 932 (e.g., configured to select a model from among a plurality of models, such as based on input data), parameter engine 934 (e.g., configured to add, remove, and/or change one or more parameters of a model), and/or model generation engine 936 (e.g., configured to generate one or more machine learning models, such as according to model input data, model output data, comparison data, and/or validation data).

In some embodiments, model selector engine 932 may be configured to receive input and/or transmit output to ML algorithms database 970. Similarly, featurization engine 920 can utilize storage or system memory for storing data and can utilize one or more I/O devices or network interfaces for transmitting or receiving data. ML algorithms database 970 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a diffusion model, a diffusion-transformer model, an encoder such as BERT (Bidirectional Encoder Representations from Transformers) or LXMERT (Learning Cross-Modality Encoder Representations from Transformers), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, or any other type of model described further herein. Some of the ML algorithms in ML algorithms database 970 can be considered generative response engines. Generative response engines are those models are commonly referred to as Generative AI, and that can receive an input prompt and generate additional content based on the prompt. GPTs, diffusion models, and diffusion-transformer models are some non-limiting examples of generative response engines. Some specific examples of generative response engines that can be stored in the ML algorithms database 970 include versions DALL·E, CHAT GPT, and SORA, all provided by OPEN AI.

System 900 can further include predictive output generation engine 945 and output validation engine 950 (e.g., configured to apply validation data to machine learning model output). Predictive output generation engine 945 can analyze the input and identify relevant patterns and associations in the data it has learned to generate a sequence of words that predictive output generation engine 945 predicts is the most likely continuation of the input using one or more models from the ML algorithms database 970, aiming to provide a coherent and contextually relevant answer. Predictive output generation engine 945 generates responses by sampling from the probability distribution of possible words and sequences, guided by the patterns observed during its training. In some embodiments, predictive output generation engine 945 can generate multiple possible responses before presenting the final one. Predictive output generation engine 945 can generate multiple responses based on the input, and these responses are variations that predictive output generation engine 945 considers potentially relevant and coherent. Output validation engine 950 can evaluate these generated responses based on certain criteria. These criteria can include relevance to the prompt, coherence, fluency, and sometimes adherence to specific guidelines or rules, depending on the application. Based on this evaluation, output validation engine 950 selects the most appropriate response. This selection is typically the one that scores highest on the set criteria, balancing factors like relevance, informativeness, and coherence.

System 900 can further include feedback engine 960 (e.g., configured to apply feedback from a user and/or machine to a model) and model refinement engine 955 (e.g., configured to update or re-configure a model). In some embodiments, feedback engine 960 may receive input and/or transmit output (e.g., output from a trained, partially trained, or untrained model) to outcome metrics database 965. Outcome metrics database 965 may be configured to store output from one or more models and may also be configured to associate output with one or more models. In some embodiments, outcome metrics database 965, or other device (e.g., model refinement engine 955 or feedback engine 960), may be configured to correlate output, detect trends in output data, and/or infer a change to input or model parameters to cause a particular model output or type of model output. In some embodiments, model refinement engine 855 may receive output from predictive output generation engine 845 or output validation engine 850. In some embodiments, model refinement engine 855 may transmit the received output to featurization engine 820 or ML modeling engine 830 in one or more iterative cycles.

The engines of system 900 may be packaged functional hardware units designed for use with other components or a part of a program that performs a particular function (e.g., of related functions). Any or each of these modules may be implemented using a computing device. In some embodiments, the functionality of system 900 may be split across multiple computing devices to allow for distributed processing of the data, which may improve output speed and reduce computational load on individual devices. In some embodiments, system 900 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 900 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

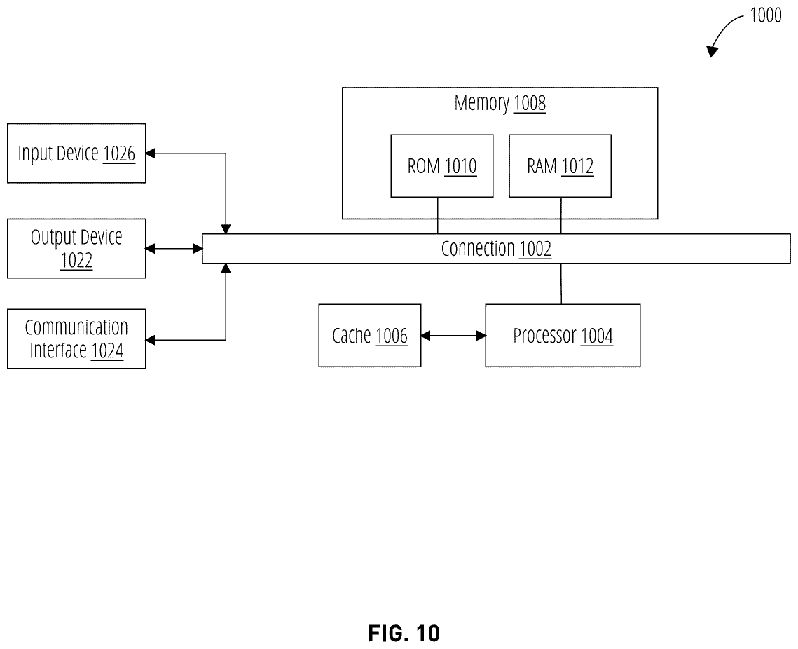

FIG. 10 shows an example of computing system 1000, which can be, for example, any computing device making up any engine illustrated in FIG. 1 or any component thereof. Further, computing system 1000 can be any computing device making up CoT system 202, CoT model 210, CoT inference engine 220, and/or summary engine 226 illustrated in FIG. 2B or any component thereof. Additionally, computing system 900 can be any computing device performing any of the steps or processes of method 300 illustrated in FIG. 3 or any component thereof.

In some embodiments, computing system 1000 is a single device, or a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

In some embodiments, computing system 1000 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 1000 includes at least one processing unit (CPU or processor) 1004 and connection 1002 that couples various system components including system memory 1008, such as read-only memory (ROM) 1010 and random access memory (RAM) 1012 to processor 1004. Memory 1008 can be a volatile or non-volatile memory device and can be a hard disk or other types of non-transitory computer-readable media that can store data that are accessible by a computer, such as magnetic cassettes, flash memory cards, solid state memory devices, digital versatile disks, cartridges, random access memories (RAMs), read-only memory (ROM), and/or some combination of these devices.

Memory 1008 can include software services, servers, logic, etc., that when the code that defines such software is executed by the processor 1004, it causes the system to perform a function. In some embodiments, a hardware service that performs a particular function can include the software component stored in a computer-readable medium in connection with the necessary hardware components, such as processor 1004, connection 1002, output device 1022, etc., to carry out the function.

Computing system 1000 can include a cache of high-speed memory 1006 connected directly with, in close proximity to, or integrated as part of processor 1004.

Connection 1002 can be a physical connection via a bus, or a direct connection into processor 1004, such as in a chipset architecture. Connection 1002 can also be a virtual connection, networked connection, or logical connection.

Processor 1004 can include any general-purpose processor and a hardware service or software service stored in memory 1008, configured to control processor 1004 as well as a special-purpose processor where software instructions are incorporated into the actual processor design. Processor 1004 may essentially be a completely self-contained computing system, containing multiple cores or processors, a bus, a memory controller, a cache, etc. A multi-core processor may be symmetric or asymmetric. Processor 1004 can be physcial or virtual.

To enable user interaction, computing system 1000 includes an input device 1026, which can represent any number of input mechanisms, such as a microphone for speech, a touch-sensitive screen for gesture or graphical input, keyboard, mouse, motion input, speech, etc. Computing system 1000 can also include output device 1022, which can be one or more of a number of output mechanisms known to those of skill in the art. In some instances, multimodal systems can enable a user to provide multiple types of input/output to communicate with computing system 1000. Computing system 1000 can include communication interface 1024, which can generally govern and manage the user input and system output. There is no restriction on operating on any particular hardware arrangement, and therefore the basic features here may easily be substituted for improved hardware or firmware arrangements as they are developed.

In some embodiments, computing system 1000 can refer to a combination of a personal computing device interacting with components hosted in a data center, where both the computing device and the components are in the data center. In such examples, both the personal computing device and the components in the data center might have a processor, cache, memory, storage, etc.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, For example, instructions and data which cause or otherwise configure a general purpose computer, special purpose computer, or special purpose processing device to perform a certain function or group of functions. Portions of computer resources used can be accessible over a network. The executable computer instructions may be, For example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### Aspects:

The present technology includes computer-readable storage mediums for storing instructions, and systems for executing any one of the methods embodied in the instructions addressed in the aspects of the present technology presented below:

Aspect 1. A method of performing chain-of-thought (CoT) reasoning using one or more machine learning (ML) models, the method comprising: receiving, from a requester, a prompt that is a request for a response, wherein the response benefits from multi-step reasoning: tokenizing the prompt to generate prompt tokens, wherein first tokens include the prompt tokens; processing, by a first ML model, the first tokens to generate second tokens, the second tokens that explore one or more reasoning frameworks for responding to the prompt; processing a combination of the first tokens and the second tokens to generate third tokens representing the response; and providing, to the requester, the response without information representing the second tokens.

Aspect 2. The method of aspect 1, further comprising: processing the second tokens to generate a summary of an applied framework of the one or more reasoning frameworks, wherein the applied framework is a framework of the one or more reasoning frameworks that is applied to generate the third tokens, the summary represents a description of the applied framework, and the response represents a reply to the prompt that is generated using the applied framework.

Aspect 3. The method of aspect 2, further comprising: causing the response together with the summary to be presented in a user interface, wherein a presentation of the summary in the user interface is configured to be collapsed and expanded, and the user interface includes a time representing a period over which the second tokens were generated.

Aspect 4. The method of aspect 3, wherein: the user interface further presents a time value representing a period over which the second tokens were generated, and the summary includes respective titles and respective descriptions corresponding to steps within the applied framework.

Aspect 5. The method of any of aspects 2-4, wherein: the summary is presented inline with the response, or the summary is presented in a panel offset from a presentation of the response.

Aspect 6. The method of any of aspects 1-5, wherein processing the combination of the first tokens and the second tokens to generate the third tokens further includes, after a period during which the first tokens are processed to generate the second tokens, streaming the response to the requester as the third tokens are generated using an autoregressive ML method.

Aspect 7. The method of any of aspects 1-6, further comprising: determining, by the first ML model, chunks of the second tokens that represent steps of an applied framework of the one or more reasoning frameworks, and processing the chunks of the second tokens to generate step summaries of the respective steps as the chunks of the second tokens are being determined, such that a step summary of a first step of the steps is generated based on a first chunk before a second chunk corresponding to a second step has been determined, wherein a summary of the applied framework comprises the step summaries.

Aspect 8. The method of aspect 7, wherein the step summary of the first step is generated before generation of the second tokens is complete.

Aspect 9. The method of aspect 7, wherein: a second ML model processes the chunks of the second tokens to generate the step summaries, the first ML model uses a chain-of-thought functionality to develop a multi-step framework for responding to the prompt, and the second ML model is a language model that lacks the chain-of-thought functionality.

Aspect 10. The method of aspect any of aspects 7, wherein a conversation thread resulting from generation of the second tokens, the third tokens and the summary comprises information of the first tokens and the third tokens but lacks information of the second tokens and the summary.

Aspect 11. The method of aspect 9, wherein the first ML model and the second ML model respectively comprise autoregressive ML models that generate one token at a time in response to previous tokens comprising input tokens and previously generated output tokens.

Aspect 12. The method of any of aspects 1-11, further comprising: generating a summary of a series of steps of a chain-of-thought framework of the second tokens; and providing the summary to the requester, Aspect 13. The method of aspect 12, wherein the summary indicates steps applied by the second model to generate the response, and the summary suggests a path for verifying the response.

Aspect 14. The method of any of aspects 1-13, wherein a conversation thread resulting from generation of the second tokens and the third tokens comprises information of the first tokens and the third tokens but lacks information of the second tokens.

Aspect 15. The method of aspect 12, wherein the series of steps comprise links in chain-of-thought reasoning in which each link is logically connected to adjacent links.

Aspect 16. The method of any of aspects 1-15, wherein the requester is an application programming interface (API).

Aspect 17. The method of any of aspects 1-16, further comprising: concatenating the response to a conversation that comprises the prompt and a context provided before the prompt is received from the requester.

Aspect 12. A non-transitory computer readable medium comprising one or more sequences of instructions, which, when executed by a processor, cause a computing system associated with a content management system to perform operations of the method of any of aspects 1-17.

Aspect 13. A computing system comprising: one or more processors; and a memory having programming instructions stored thereon, which, when executed by the one or more processors, causes the computing system to perform operations of the method of any of aspects 1-17.

What is claimed is:

1. A method of performing chain-of-thought (CoT) reasoning using one or more machine learning (ML) models, the method comprising:
receiving, from a requester, a prompt that is a request for a response, wherein the response benefits from multi-step reasoning:
tokenizing the prompt to generate prompt tokens, wherein first tokens include the prompt tokens;
processing, by a first ML model, the first tokens to generate second tokens, the second tokens that explore one or more reasoning frameworks for responding to the prompt;
processing a combination of the first tokens and the second tokens to generate third tokens representing the response; and
providing, to the requester, the response without information representing the second tokens.

2. The method of claim 1, further comprising:
processing the second tokens to generate a summary of an applied framework of the one or more reasoning frameworks, wherein
the applied framework is a framework of the one or more reasoning frameworks that is applied to generate the third tokens,
the summary represents a description of the applied framework, and
the response represents a reply to the prompt that is generated using the applied framework.

3. The method of claim 2, further comprising:
causing the response together with the summary to be presented in a user interface, wherein
a presentation of the summary in the user interface is configured to be collapsed and expanded, and the user interface includes a time representing a period over which the second tokens were generated.

4. The method of claim 3, wherein:
the user interface further presents a time value representing a period over which the second tokens were generated, and
the summary includes respective titles and respective descriptions corresponding to steps within the applied framework.

5. The method of claim 2, wherein:
the summary is presented inline with the response, or
the summary is presented in a panel offset from a presentation of the response.

6. The method of claim 1, wherein processing the combination of the first tokens and the second tokens to generate the third tokens further includes, after a period during which the first tokens are processed to generate the second tokens, streaming the response to the requester as the third tokens are generated using an autoregressive ML method.

7. The method of claim 1, further comprising:
determining, by the first ML model, chunks of the second tokens that represent steps of an applied framework of the one or more reasoning frameworks, and
processing the chunks of the second tokens to generate step summaries of the respective steps as the chunks of the second tokens are being determined, such that a step summary of a first step of the steps is generated based on a first chunk before a second chunk corresponding to a second step has been determined, wherein
a summary of the applied framework comprises the step summaries.

8. The method of claim 7, wherein the step summary of the first step is generated before generation of the second tokens is complete.

9. The method of claim 7, wherein a conversation thread resulting from generation of the second tokens, the third tokens and the summary comprises information of the first tokens and the third tokens but lacks information of the second tokens and the summary.

10. The method of claim 7, wherein:
a second ML model processes the chunks of the second tokens to generate the step summaries,
the first ML model uses a chain-of-thought functionality to develop a multi-step framework for responding to the prompt, and
the second ML model is a language model that lacks the chain-of-thought functionality.

11. The method of claim 10, wherein the first ML model and the second ML model respectively comprise autoregressive ML models that generate one token at a time in response to previous tokens comprising input tokens and previously generated output tokens.

12. The method of claim 1, wherein the summary describes steps of an applied framework used to generate the response based on the second tokens, and the summary suggests a path for verifying the response and the applied framework.

13. The method of claim 1, wherein the requester is an application programming interface (API).

14. A computing apparatus comprising:
a processor; and
a memory storing instructions that, when executed by the processor, configure the apparatus to perform operations:
receiving, from a requester, a prompt that is a request for a response, wherein the response benefits from multi-step reasoning:
tokenizing the prompt to generate prompt tokens, wherein first tokens include the prompt tokens;
processing, by a first ML model, the first tokens to generate second tokens, the second tokens that explore one or more reasoning frameworks for responding to the prompt;
processing a combination of the first tokens and the second tokens to generate third tokens representing the response; and
providing, to the requester, the response without information representing the second tokens.

15. The computing apparatus of claim 14, wherein the instructions further configure the apparatus to perform operations:
processing the second tokens to generate a summary of an applied framework of the one or more reasoning frameworks, the applied framework being a framework of the one or more reasoning frameworks that is applied to generate the third tokens; and
causing the response together with the summary to be presented in a user interface, wherein
the summary represents a description of the applied framework, and
the response represents a reply to the prompt that is generated using the applied framework.

16. The computing apparatus of claim 14, wherein the instructions further configure the apparatus to perform operations:
determining, by the first ML model, chunks of the second tokens that represent steps of an applied framework of the one or more reasoning frameworks, and
processing the chunks of the second tokens to generate step summaries of the respective steps as the chunks of the second tokens are being determined, such that a step summary of a first step of the steps is generated based on a first chunk before a second chunk corresponding to a second step has been determined, wherein
a summary of the applied framework comprises the step summaries.

17. The computing apparatus of claim 16, wherein:
a second ML model processes the chunks of the second tokens to generate the step summaries,
the first ML model uses a chain-of-thought functionality to develop a multi-step framework for responding to the prompt, and
the second ML model is a language model that lacks the chain-of-thought functionality.

18. The computing apparatus of claim 16, wherein a conversation thread resulting from generation of the second tokens, the third tokens and the summary comprises information of the first tokens and the third tokens but lacks information of the second tokens and the summary.

19. The computing apparatus of claim 14, wherein a conversation thread resulting from generation of the second tokens and the third tokens comprises information of the first tokens and the third tokens but lacks information of the second tokens.

20. A non-transitory computer-readable storage medium, the computer-readable storage medium including instructions that when executed by a computer, cause the computer to:
receive, from a requester, a prompt that is a request for a response, wherein the response benefits from multi-step reasoning:
tokenizing the prompt to generate prompt tokens, wherein first tokens include the prompt tokens;
process, by a first ML model, the first tokens to generate second tokens, the second tokens that explore one or more reasoning frameworks for responding to the prompt;
process a combination of the first tokens and the second tokens to generate third tokens representing the response; and
provide, to the requester, the response without information representing the second tokens.
